(19) United States
(12) Patent Application Publication
(10) Pub. No.: US 2015/0220496 A1
(43) Pub. Date: Aug. 6, 2015

(54) DYNAMIC SPRITE BASED THEME SWITCHING

(71) Applicant: SugarCRM Inc., Cupertino, CA (US)

(72) Inventor: Jelle Vink, Gilroy, CA (US)

(73) Assignee: SugarCRM Inc., Cupertino, CA (US)

(21) Appl. No.: 14/173,814

(22) Filed: Feb. 6, 2014

(51) Int. Cl. G06F 17/22; G06T 13/80

(52) U.S. Cl. CPC G06F 17/227; G06T 13/80

(57) ABSTRACT

A method for dynamic theme switching utilizing content stylesheet (CSS) sprites is provided. A user interface (UI) is defined for a computer program. A display of the UI is formatted according to a stylesheet and includes different UI controls. The display characteristics of the UI controls are defined according to a theme and multiple different themes are specified for the UI controls with only a single theme applied at a time. The UI controls are grouped with a particular theme applied within a single image as a CSS sprite. Further, the same UI controls are separately grouped with a different theme applied within a single image as a different CSS sprite. Consequently, a display of the UI according to one theme can be dynamically switched to a different theme by referencing the different CSS sprite in the stylesheet in lieu of the CSS sprite of the one theme.

### BACKGROUND OF THE INVENTION

1. Field of the Invention

The present invention relates to cascading style sheet (CSS) sprites and more particularly to master image loading of a CSS sprite in a Web page.

2. Description of the Related Art

Sprite is a computer graphics term used to refer to two-dimensional graphical overlays that can be animated and placed into a larger scene. In sprite-based animation, graphical images are sequentially ordered to produce the illusion of movement in various media. Sprites originally were integrated as unrelated bitmaps into a primary display of a bitmap so that the sprites appeared to be part of the bitmap of the primary display. Exemplary applications included the creation of an animated character movable about a screen display without altering the data defining the screen display. Sprites historically have found particular application in computer gaming. Specifically, the increase in the complexity of video gaming displays necessitated intelligent ways to handle detailed graphic objects while providing a smooth visual effect.

Recently, sprite technologies have evolved from computer gaming to Web site publishing. In this regard, sprites have been incorporated into CSS based Web content by consolidating multiple images used throughout a Web site into a “master image.” To display a single one of the multiple images from the master image, the background position of the property of the CSS is used to define the exact position of the one of the multiple images to be displayed. Likewise, hover, active or focus effects can be implemented using the simple definition of the background-position property for the displayed element. Thus, in operation, when the CSS defined Web page is loaded, the page loads not the individual images of the master image one by one, but the entire master image at once.

CSS sprites are commonly used, particularly for navigation such as for hover effects, icons and buttons. In this regard, JavaScript-based hover, active and focus effects that ordinarily require two hypertext transfer protocol (HTTP) requests for each image resulting in “flickering”, require no additional HTTP requests with CSS sprites because the master image is loaded with the whole page only once. It should be apparent, then that CSS sprites generally reduce HTTP requests and the loading time of pages. As such, CSS sprites are often used in connection with Web sites with heavy traffic, where millions of page impressions would utilize “only” a tiny fraction of what could otherwise be many millions of requests.

### BRIEF SUMMARY OF THE INVENTION

Embodiments of the present invention address deficiencies of the art in respect to CSS sprite utilization and provide a novel and non-obvious method, system and computer program product for dynamic theme switching utilizing CSS sprites. In an embodiment of the invention, a method of dynamic theme switching utilizing sprites is provided. The method includes loading into memory of a computer a stylesheet defining an arrangement and display of different user interface controls of a user interface to an application and identifying within the stylesheet, a reference to a sprite comprising a single bitmap image of multiple different ones of the user interface controls according to specified display characteristics. The method also includes assembling a page for the user interface including the referenced sprite and transmitting the page to a requesting content browser over a computer communications network. Finally, the method includes responding to a request to change a theme of the user interface to a different theme by modifying the stylesheet to reference a different sprite associated with the different theme, re-assembling a page for the user interface including the referenced different sprite and transmitting the re-assembled page to the content browser over the computer communications network.

In another embodiment of the invention, a computer data processing system is configured for dynamic theme switching utilizing sprites. The system includes a host computing platform including at least one host server with memory and at least one processor and configured for communicative coupling over a computer communications network to different client computers, each with a corresponding content browser. The system also includes an application executing in the memory of the host computing platform and a sprite data store storing multiple different sprites, each corresponding to a differently themed version of a user interface to the application.

The system further includes a Web server executing in the memory of the host computing platform and transmitting different pages to different ones of the client computers in response to requests for the different pages, or in response to directives received from the application, at least one of the pages that includes user interface controls configured according to a single theme. In this regard, the user interface controls are grouped together into a single bitmap of one of the sprites in the sprite data store and specified by a reference in a corresponding stylesheet. Finally, the system can include a sprite generation module coupled to the application. The module includes program code enabled to respond to a request to persist a new theme for the user interface controls by generating and storing in the sprite data store a sprite comprising the user interface controls configured according to a specified selection of visual characteristics.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for dynamic theme switching utilizing CSS sprites;

FIG. 2 is a schematic illustration of a computer data processing system configured for dynamic theme switching utilizing CSS sprites;

FIG. 3 is a flow chart illustrating a process for CSS sprite generation during dynamic theme switching; and,

FIG. 4 is a flow chart illustrating a process for dynamic theme switching utilizing CSS sprites.

### DETAILED DESCRIPTION OF THE INVENTION

Embodiments of the invention provide for dynamic theme switching utilizing CSS sprites. In accordance with an embodiment of the invention, a user interface can be defined for a computer program, for instance a CRM application. A display of the user interface can be formatted according to a stylesheet and can include different user interface controls. The display characteristics of the user interface controls can be defined according to a theme and multiple different themes can be specified for the same user interface controls with only a single theme applied at any given time. Notably, the user interface controls can be grouped together with a particular one of the themes applied within a single image as a CSS sprite. Further, the same user interface controls can be separately grouped together with a different one of the themes applied within a single image as a different CSS sprite. Consequently, a display of the user interface according to one theme can be dynamically switched to one of a different them merely by referencing the different CSS sprite in the stylesheet in lieu of the CSS sprite of the particular one of the themes.

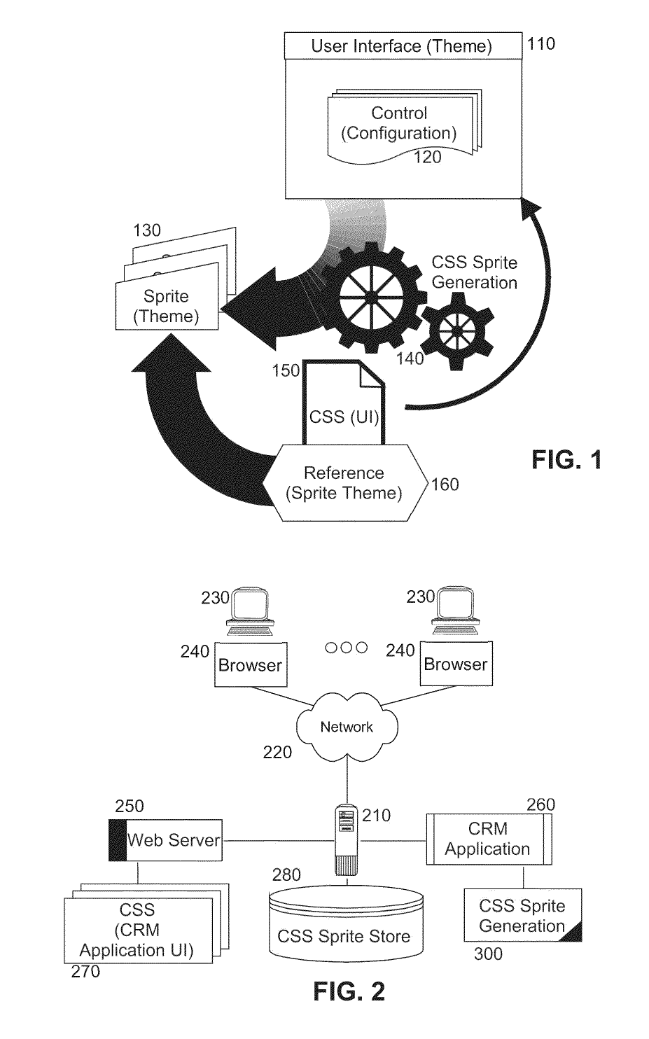

In further illustration, FIG. 1 pictorially shows a process for dynamic theme switching utilizing CSS sprites. As shown in FIG. 1, a page providing a user interface 110 for an application can be defined according to a stylesheet 150. The user interface 110 include different user interface controls 120 such as windows, drop down boxes, buttons, static text fields, text input fields and the like. The display characteristics of the user interface controls 120 can be specified as a configured theme and can include, by way of example, specified border colors and fill colors, specified background and foreground colors, specified border styles and thickness, and other visual display characteristics.

In response to the configuration of the user interface controls 120 as a theme, CSS sprite generation logic 140 can generate a CSS sprite 130 for a grouping of the user interface controls 120 configured with the specific display characteristics. Thereafter, a reference 160 to the CSS sprite 130 of the theme can be disposed within the stylesheet 150 such that a reloading of the page can load the user interface controls 120 of the user interface 110 as the CSS sprite 130 associated with the theme of the specific display characteristics. Further, the theme of the user interface 110 can be dynamically switched simply by changing the reference 160 to refer to a different CSS sprite for a different them of different display characteristics of the user interface controls 120. In this way, theme switching can be dynamic and efficient through the use of CSS sprites.

The process described in connection with FIG. 1 can be implemented within a computer data processing system. In yet further illustration, FIG. 2 schematically shows a computer data processing system configured for dynamic theme switching utilizing CSS sprites. The system can include a host server 210 with at least one processor and memory configured for communicative coupling to different clients 230 over a computer communications network 220, for example the global Internet. Each of the clients 230 can support the operation of a content browser 240 through which different pages can be retrieved from over the computer communications network 220 and rendered for viewing by an end user.

The host server 210 can include a Web server 250. The Web server 250 can be configured to provide different pages of content over the computer communications network 220 upon request by different ones of the content browsers 240. Further, the Web server 250 can be configured to dynamically assemble pages of content as specified by corresponding stylesheets 270. The stylesheets 270 individually can refer to different CSS sprites in a sprite data store 280 so that groupings of user interface controls can be provided as part of a pages as a single bitmapped image.

Yet further, the Web server 250 can facilitate communication between the content browsers 240 and a supported application 260, such as a CRM application 260. In this regard, requests from individual ones of the clients 230 generated through pages rendered in respective ones of the browsers 240 can be provided over the computer communications network 220 to the Web server 250 and, in turn, to the application 260 for processing. The application 260, in turn, can process the individual requests and direct the Web server 250 to provide different pages to the requests clients for rendering in corresponding ones of the content browsers 240.

Of note, a CSS sprite generation module 300 can be coupled to the application 260. The CSS sprite generation module 300 can include program code that when executed in the memory of the host server 210, can be enabled to respond to a request to configure display characteristics of different controls in a page acting as a user interface to the application 260 by grouping the different controls as configured as a particular theme into a single CSS sprite and storing the single CSS sprite in the sprite data store 280 in association with the particular theme. The program code of the CSS sprite generation module 300 further can be enabled to set a reference within one of the stylesheets 270 to the single CSS sprite so that upon loading a page corresponding to the one of the stylesheets 270, the single CSS sprite is loaded to reflect the particular theme in the user interface to the application 260.

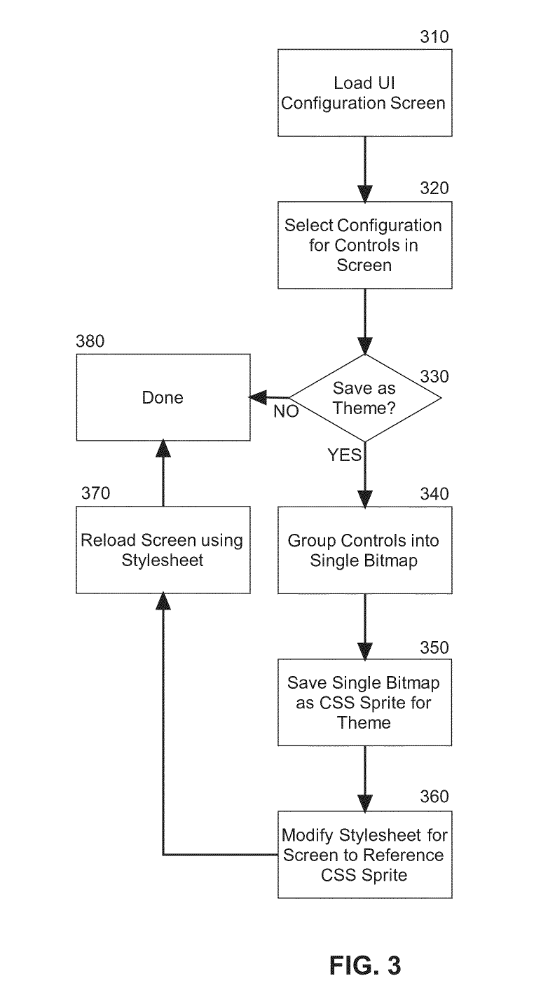

In even yet further illustration of the operation of the CSS sprite generation module 300, FIG. 3 is a flow chart illustrating a process for generating a CSS sprite during dynamic theme. Beginning in block 310, a user interface configuration screen can be loaded into memory through which an end user can specify display characteristics of different user interface controls of a corresponding user interface to an application. In block 320, the display characteristics of different ones of the user interface controls can be specified within the user interface configuration screen and in decision block 330, it can be determined whether or not to persist the specified display characteristics as a theme of the user interface of the application. If not, the process can end in block 380. Otherwise, the process can continue in block 340.

In block 340, the controls configured with the specified display characteristics can be grouped together into a single bitmap image and persisted in block 350 as a CSS sprite in association with a new theme for the application. In block 360, a stylesheet corresponding to the user interface can be modified to reference the persisted CSS sprite. Subsequently, in block 370, a page for the user interface can be re-assembled according to the stylesheet including a rendering of the CSS sprite reflecting the new theme. Finally, in block 380 the process can end.

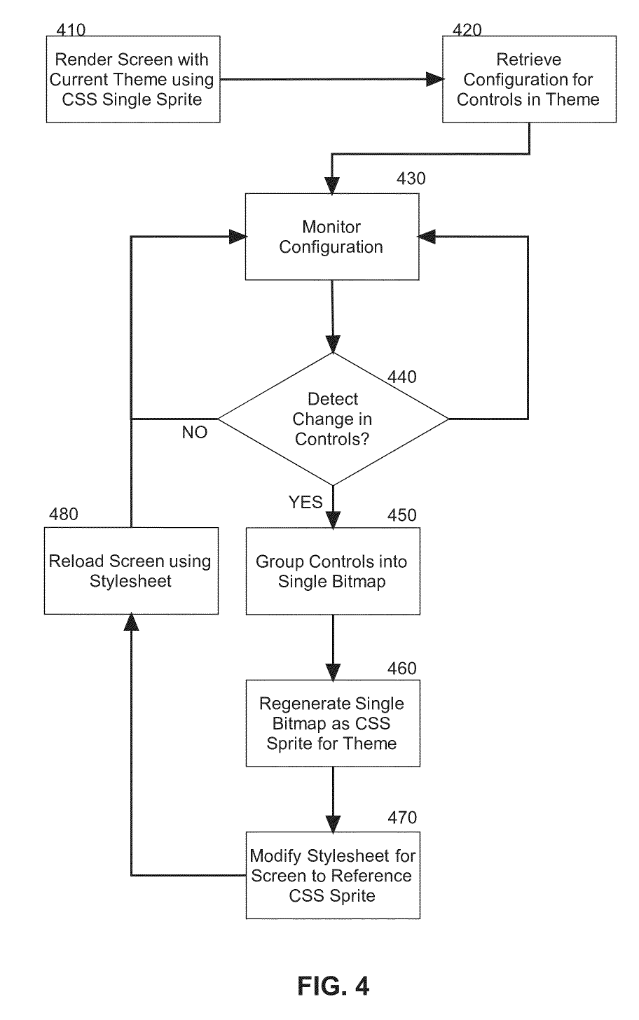

Once a CSS sprite has been generated for use in connection with a theme, a screen utilizing the CSS sprite can be displayed and monitored for changes to controls in the set of controls of the display. Thereafter, in response to detecting a change in the configuration of controls in the set, a new CSS sprite can be generated for a new theme reflective of the detected change in configuration of the controls. In further illustration, FIG. 4 is a flow chart illustrating a process for dynamic theme switching utilizing CSS sprites.

Beginning in block 410, a screen can be generated with a current theme utilizing a CSS single sprite. In block 420, a configuration of controls in a set of controls for the theme can be retrieved into memory and the configuration can be monitored for changes. In decision block 440, responsive to detecting a change in the configuration, in block 450 the controls configured with the specified display characteristics can be grouped together into a single bitmap image and persisted in block 460 as a new CSS sprite in association with a new theme for the application. In block 470, a stylesheet corresponding to the user interface can be modified to reference the persisted CSS sprite. Subsequently, in block 480, a page for the user interface can be re-assembled according to the stylesheet including a rendering of the CSS sprite reflecting the new theme. Finally, the process can return to block 430 in which additional changes in configuration can be monitored.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of dynamic theme switching utilizing sprites, the method comprising:
loading into memory of a computer a stylesheet defining an arrangement and display of different user interface controls of a user interface to an application;
identifying within the stylesheet, a reference to a sprite comprising a single bitmap image of multiple different ones of the user interface controls according to specified display characteristics;
assembling a page for the user interface including the referenced sprite and transmitting the page to a requesting content browser over a computer communications network; and,
responsive to a request to change a theme of the user interface to a different theme, modifying the stylesheet to reference a different sprite associated with the different theme, re-assembling a page for the user interface including the referenced different sprite and transmitting the re-assembled page to the content browser over the computer communications network.

2. The method of claim 1, wherein the stylesheet is a content stylesheet (CSS).

3. The method of claim 1, wherein the display characteristics include specified border colors and fill colors, specified background and foreground colors, and specified border styles and thickness.

4. The method of claim 1, wherein the application is a customer relationship management (CRM) application.

5. The method of claim 1, further comprising:
receiving from an end user a request to specify a new theme of new display characteristics for the user interface controls;
persisting the user interface controls with the new theme applied as a new sprite; and,
modifying the stylesheet to reference the new sprite associated with the new theme, re-assembling a page for the user interface including the referenced new sprite and transmitting the re-assembled page to the content browser over the computer communications network.

6. A computer data processing system configured for dynamic theme switching utilizing sprites, the system comprising:
a host computing platform comprising at least one host server comprising memory and at least one processor and configured for communicative coupling over a computer communications network to different client computers, each with a corresponding content browser;
an application executing in the memory of the host computing platform;
a sprite data store comprising multiple different sprites, each corresponding to a differently themed version of a user interface to the application;
a Web server executing in the memory of the host computing platform and transmitting different pages to different ones of the client computers in response to requests for the different pages, or in response to directives received from the application, at least one of the pages comprising a plurality of user interface controls configured according to a single theme, the user interface controls grouped together into a single bitmap of one of the sprites in the sprite data store and specified by a reference in a corresponding stylesheet; and,
a sprite generation module coupled to the application, the module comprising program code enabled to respond to a request to persist a new theme for the user interface controls by generating and storing in the sprite data store a sprite comprising the user interface controls configured according to a specified selection of visual characteristics.

7. The system of claim 6, wherein the stylesheet is a content stylesheet (CSS).

8. The system of claim 6, wherein the display characteristics include specified border colors and fill colors, specified background and foreground colors, and specified border styles and thickness.

9. The system of claim 6, wherein the application is a customer relationship management (CRM) application.

10. A computer program product for dynamic theme switching utilizing sprites, the computer program product comprising:
a computer readable storage medium having computer readable program code embodied therewith, the computer readable program code comprising:
computer readable program code for loading into memory of a computer a stylesheet defining an arrangement and display of different user interface controls of a user interface to an application;
computer readable program code for identifying within the stylesheet, a reference to a sprite comprising a single bitmap image of multiple different ones of the user interface controls according to specified display characteristics;
computer readable program code for assembling a page for the user interface including the referenced sprite and transmitting the page to a requesting content browser over a computer communications network; and,
computer readable program code for responding to a request to change a theme of the user interface to a different theme by modifying the stylesheet to reference a different sprite associated with the different theme, re-assembling a page for the user interface including the referenced different sprite and transmitting the re-assembled page to the content browser over the computer communications network.

11. The computer program product of claim 10, wherein the stylesheet is a content stylesheet (CSS).

12. The computer program product of claim 10, wherein the display characteristics include specified border colors and fill colors, specified background and foreground colors, and specified border styles and thickness.

13. The computer program product of claim 10, wherein the application is a customer relationship management (CRM) application.

14. The computer program product of claim 10, further comprising:
computer readable program code for receiving from an end user a request to specify a new theme of new display characteristics for the user interface controls;
computer readable program code for persisting the user interface controls with the new theme applied as a new sprite; and,
computer readable program code for modifying the stylesheet to reference the new sprite associated with the new theme, re-assembling a page for the user interface including the referenced new sprite and transmitting the re-assembled page to the content browser over the computer communications network.

15. A method of dynamic theme switching utilizing sprites, the method comprising:
loading into memory of a computer a stylesheet defining an arrangement and display of different user interface controls of a user interface to an application;
identifying within the stylesheet, a reference to a sprite comprising a single bitmap image of multiple different ones of the user interface controls according to specified display characteristics;
assembling a page for the user interface including the referenced sprite and transmitting the page to a requesting content browser over a computer communications network; and,
responsive to detecting a change in configuration of the different user interface controls, re-generating a new single bitmap image of the new configuration of the different user interface controls as a new sprite, modifying the stylesheet to reference the new sprite, assembling a new page for the user interface including the referenced new sprite, and transmitting the page to the content browser over the computer communications network.

16. The method of claim 15, wherein the stylesheet is a content stylesheet (CSS).

17. The method of claim 15, wherein the display characteristics include specified border colors and fill colors, specified background and foreground colors, and specified border styles and thickness.

18. The method of claim 15, wherein the application is a customer relationship management (CRM) application.
